(19) United States
(12) Patent Application Publication
(10) Pub. No.: US 2026/0084091 A1
(43) Pub. Date: Mar. 26, 2026

(54) CARBON DIOXIDE REMOVAL SYSTEM

(71) Applicant: MITSUBISHI HEAVY INDUSTRIES, LTD., Tokyo (JP)

(72) Inventors: Shunya Doi, Tokyo (JP); Taisuke Tsukamoto, Tokyo (JP); Naoki Ogawa, Tokyo (JP); Masaki Morinaka, Tokyo (JP); Sayaka Maruta, Tokyo (JP); Rieko Menjo, Tokyo (JP); Hiroki Matsumoto, Tokyo (JP)

(21) Appl. No.: 19/332,716

(22) Filed: Sep. 18, 2025

(30) Foreign Application Priority Data
Sep. 20, 2024 (JP) 2024-164229

(51) Int. Cl. B01D 53/047; B01D 53/04; B01D 53/62

(52) U.S. Cl. CPC B01D 53/047; B01D 53/0446; B01D 53/0462; B01D 53/62; B01D 2253/25; B01D 2257/504; B01D 2259/40007; B01D 2259/40028; B01D 2259/402

(57) ABSTRACT

A carbon dioxide removal system includes: a flow path through which a target gas flows; a treatment unit including adsorption towers connected in series in the flow path; and a control device that switches between paths of the target gas. The flow path includes: a first main path that supplies the target gas to the treatment unit; a first recovery path that discharges, to a target space, the target gas passed through the first main path; a desorption path connected to the adsorption towers; a first branch path that connects a path between the adsorption towers on upstream and downstream sides to the first recovery path; and a switching mechanism that switches a path through which the target gas flows. The desorption path is connectable in parallel to the adsorption towers.

### CROSS-REFERENCE TO RELATED APPLICATIONS

The present application claims priority to and incorporates by reference the entire contents of Japanese Patent Application No. 2024-164229 filed in Japan on Sep. 20, 2024.

### FIELD

The present disclosure relates to a carbon dioxide removal system configured to recover carbon dioxide from air.

### BACKGROUND

There are technologies to recover carbon dioxide from gas. Patent Literature 1 describes a system configured to separate carbon dioxide contained in source gas from the source gas by adjusting pressure while adjusting temperature by using the PSA method that increases or decreases pressure in an adsorption tower to switch between adsorption and desorption.

### CITATION LIST

### Patent Literature

Patent Literature 1: Japanese Patent No. 7207626

### SUMMARY

### Technical Problem

Here, a system configured to separate carbon dioxide not only performs adsorption under normal pressure and normal temperature, but also sometimes performs pressurization and cooling for the adsorption. When a cycle operation between adsorption and desorption is performed, desorption is performed by switching to depressurization and heating, hence electric power is consumed. When the system is used in an environment with a limited amount of electric power used, there is a possibility that the operation of the system is limited.

The present disclosure solves the problem described above, and an object thereof is to provide a carbon dioxide removal system that can control adsorption and desorption of carbon dioxide according to situations.

### Solution to Problem

To solve the above problem and achieve the above object, a carbon dioxide removal system according to the present disclosure includes: a treatment target gas acquisition unit that acquires a treatment target gas from a target space; a flow path that allows the acquired treatment target gas to flow through the flow path; a treatment unit that includes two or more adsorption towers connected in series in the flow path along a flow of the treatment target gas; and a control device that switches between paths of the treatment target gas. The flow path includes: a first main path that supplies the treatment target gas to the treatment unit; a first recovery path that discharges, to the target space, the treatment target gas passed through the first main path; a desorption path that is connected to the adsorption towers to be depressurized; a first branch path that connects a path between the adsorption tower on an upstream side of the treatment unit and the adsorption tower on a downstream side of the first treatment unit to the first recovery path; and a switching mechanism that switches a path through which the treatment target gas flows. The desorption path is connectable in parallel to the plurality of adsorption towers.

To solve the above problem and achieve the above object, a carbon dioxide removal system according to the present disclosure includes: a treatment target gas acquisition unit that acquires a treatment target gas from a target space; a flow path that allows the acquired treatment target gas to flow through the flow path; a first treatment unit that includes two or more adsorption towers connected in series in the flow path along a flow of the treatment target gas; a second treatment unit that includes two or more adsorption towers connected in series in the flow path along a flow of the treatment target gas, and is disposed in parallel to the first treatment unit; and a control device that switches between paths of the treatment target gas. The flow path includes: a first main path that supplies the treatment target gas to the first treatment unit; a second main path that is disposed in parallel to the first main path, and supplies the treatment target gas to the second treatment unit; a first recovery path that discharges, to the target space, the treatment target gas passed through the first main path and the second main path; a desorption path that is connected to the adsorption towers to be depressurized; a first branch path that connects a path between the adsorption tower on an upstream side of the first treatment unit and the adsorption tower on a downstream side of the first treatment unit to the first recovery path; and a switching mechanism that switches a path through which the treatment target gas flows. The control device controls the switching mechanism disposed in the flow path, and is configured to switch between a mode of flowing the treatment target gas through all the adsorption towers of the first treatment unit and a mode of flowing the treatment target gas through the first branch path to allow the treatment target gas to flow through the adsorption tower disposed on the upstream side of the first treatment unit and not to allow the treatment target gas to flow through the adsorption tower disposed on the downstream side of the first treatment unit.

### Advantageous Effects of Invention

According to the present disclosure, adsorption and desorption of carbon dioxide can be suitably performed according to situations.

### BRIEF DESCRIPTION OF DRAWINGS

FIG. 1 is a schematic diagram of a carbon dioxide removal system according to the present embodiment.

FIG. 2 is an explanatory diagram illustrating an operation example of the carbon dioxide removal system according to the present embodiment.

FIG. 3 is an explanatory diagram illustrating an operation example of the carbon dioxide removal system according to the present embodiment.

FIG. 4 is an explanatory diagram illustrating an operation example of the carbon dioxide removal system according to the present embodiment.

FIG. 5 is an explanatory diagram illustrating an operation example of the carbon dioxide removal system according to the present embodiment.

FIG. 6 is an explanatory diagram illustrating an operation example of the carbon dioxide removal system according to the present embodiment.

FIG. 7 is an explanatory diagram illustrating an operation example of the carbon dioxide removal system according to the present embodiment.

FIG. 8 is an explanatory diagram illustrating an operation example of the carbon dioxide removal system according to the present embodiment.

FIG. 9 is an explanatory diagram illustrating an operation example of the carbon dioxide removal system according to the present embodiment.

FIG. 10 is an explanatory diagram illustrating an operation example of the carbon dioxide removal system according to the present embodiment.

FIG. 11 is a schematic diagram of a carbon dioxide removal system according to another embodiment.

FIG. 12 is an explanatory diagram illustrating an operation example of the carbon dioxide removal system illustrated in FIG. 11.

### DESCRIPTION OF EMBODIMENTS

Hereinafter, a preferred embodiment of the present invention will be described in detail with reference to the accompanying drawings. Note that the present invention is not limited by this embodiment, and, when a plurality of embodiments is provided, the present invention includes what is configured with a combination of the embodiments.

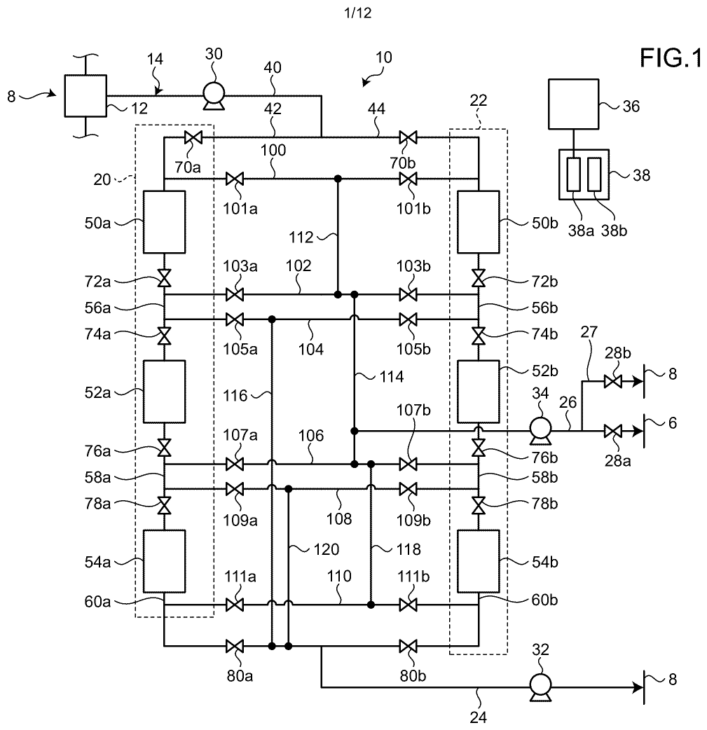

FIG. 1 is a schematic diagram of a carbon dioxide removal system according to the present embodiment. A carbon dioxide removal system 10 according to the present embodiment acquires a treatment target gas in a target space 8 and removes carbon dioxide contained in the treatment target gas. The carbon dioxide removal system 10 is a system configured to remove part of carbon dioxide from the treatment target gas and decrease the concentration of carbon dioxide in the treatment target gas. All of carbon dioxide contained in the treatment target gas may be removed. The carbon dioxide removal system 10 discharges the carbon dioxide removed from the treatment target gas to an outdoor space 6.

The target space 8 is not limited to any particular space, but is, for example, a space in which people are active. The carbon dioxide removal system 10 can be more suitably used when the target space 8 is an enclosed space in which outside air cannot be taken in. For example, when the outdoor space 6, which is outside the target space 8, is a space in which the atmosphere is polluted, which is under water, which contains less air, or which is outer space, the outdoor space 6 can be suitably used.

The carbon dioxide removal system 10 includes an intake unit (a treatment target gas acquisition unit) 12, a flow path 14, a first treatment unit 20, a second treatment unit 22, a first recovery path 24, a desorption path 26, a second recovery path 27, blowers 30 and 32, a vacuum pump 34, a control device 36, and a power source 38.

The intake unit 12 is connected to the target space 8 and takes a treatment target gas (air) in the target space 8 into the carbon dioxide removal system 10.

The flow path 14 connects the intake unit 12 to first treatment unit 20 and the second treatment unit 22 and supplies the treatment target gas taken in by the intake unit 12 to the first treatment unit 20 and the second treatment unit 22. The flow path 14 connects the first treatment unit 20 and the second treatment unit 22 to the first recovery path 24, the desorption path 26, and the second recovery path 27.

The flow path 14 includes an intake path 40, a first main path 42, a second main path 44, branch paths 100, 102, 104, 106, 108, 110, and connection paths 112, 114, 116, 118, 120. Valves are provided in the paths of the flow path 14. The intake path 40 is a pipe that connects the intake unit 12 to the first main path 42 and the second main path 44. The first main path 42 and the second main path 44 are pipes disposed in parallel In the first main path 42, a plurality of adsorption towers of the first treatment unit 20 is connected in series. The upstream end of the first main path 42 is connected to the intake path 40, and the downstream end of the first main path 42 is connected to the first recovery path 24. In the second main path 44, a plurality of adsorption towers of the second treatment unit 22 is connected in series. The upstream end of the second main path 44 is connected to the intake path 40, and the downstream end of the second main path 44 is connected to the first recovery path 24. Other paths of the flow path 14 will be described after the description of constituents connected to the flow path 14.

The first treatment unit 20 includes three adsorption towers, namely, an upstream adsorption tower 50a, a midstream adsorption tower 52a, and a downstream adsorption tower 54a. The upstream adsorption tower 50a, the midstream adsorption tower 52a, and the downstream adsorption tower 54a of the first treatment unit 20 are connected in series in the first main path 42. That is, the upstream adsorption tower 50a, the midstream adsorption tower 52a, and the downstream adsorption tower 54a are disposed in this order along a flow direction from the upstream side of the flow of the treatment target gas in the first main path 42, that is, from a side of the first main path 42 closer to connection to the intake path 40.

The second treatment unit 22 includes three adsorption towers, namely, an upstream adsorption tower 50b, a midstream adsorption tower 52b, and a downstream adsorption tower 54b. The upstream adsorption tower 50b, the midstream adsorption tower 52b, and the downstream adsorption tower 54b of the second treatment unit 22 are connected in series in the second main path 44. That is, the upstream adsorption tower 50b, the midstream adsorption tower 52b, and the downstream adsorption tower 54b are disposed in this order along a flow direction from the upstream side of the flow of the treatment target gas in the second main path 44, that is, from a side of the second main path 44 closer to connection to the intake path 40.

The upstream adsorption towers 50a, 50b, the midstream adsorption towers 52a, 52b, and the downstream adsorption towers 54a, 54b (simply referred to as the adsorption towers when no distinction is made between the adsorption towers) are filled with an adsorbent that adsorbs carbon dioxide. The adsorption towers according to the present embodiment are filled with a solid adsorbent. Various substances that adsorb carbon dioxide can be used as the adsorbent. The adsorbent is preferably a material that reversibly causes adsorption and desorption with an increase or decrease in the partial pressure of CO₂. The adsorbent preferably has the characteristic of more easily desorbing carbon dioxide as temperature increases. Examples of the adsorbent include an amine-impregnated adsorbent and a metal organic framework (MOF). An amine-impregnated adsorbent is preferably used as the adsorbent.

The upstream adsorption towers 50a, 50b, the midstream adsorption towers 52a, 52b, and the downstream adsorption towers 54a, 54b according to the present embodiment are the same in diameter and length, and are filled with the same adsorbent. That is, the upstream adsorption towers 50a, 50b, the midstream adsorption towers 52a, 52b, and the downstream adsorption towers 54a, 54b are equivalent in carbon dioxide adsorption performance to each other.

The first recovery path 24 is a pipe to which the treatment target gas having passed through the first treatment unit 20 and the second treatment unit 22 is supplied. One end of the first recovery path 24 is connected to the downstream end of the first main path 42 and the downstream end of the second main path 44, while the other end of the first recovery path 24 is connected to the target space 8. To the target space 8, the first recovery path 24 sends the treatment target gas from which carbon dioxide has been removed or reduced by the first treatment unit 20 and the second treatment unit 22.

One end of the desorption path 26 is connected to the flow path 14, while the other end of the desorption path 26 is connected to the outdoor space 6. The desorption path 26 is a pipe that guides, to the outdoor space 6, carbon dioxide generated through the treatment of separating carbon dioxide adsorbed in the adsorption towers from the adsorption towers. A valve 28a is disposed in the desorption path 26 and switches between a state in which the outdoor space 6 is connected to the adsorption towers and a state in which the outdoor space 6 is separated from the adsorption towers. Note that the desorption path 26 according to the present embodiment is configured to be connected to the outdoor space 6, but may be configured to be connected to a storage tank for storing carbon dioxide.

One end of the second recovery path 27 is connected to the desorption path 26, upstream from the valve 28a (on the adsorption tower side), while the other end of the second recovery path 27 is connected to the target space 8. The second recovery path 27 is a path through which gas flows when, out of gas discharged from the adsorption towers, gas to be returned to the target space 8 is supplied to the desorption path 26. A valve 28b is disposed in the second recovery path 27 and switches between a state in which the target space 8 is connected to the adsorption towers and a state in which the target space 8 is separated from the adsorption towers.

The blower 30 is disposed in the intake path 40. The blower 30 forms a gas flow from the intake unit 12 toward the first recovery path 24. The blower 32 is disposed in the first recovery path 24. The blower 32 forms a gas flow from the first main path 42 and the second main path 44 toward the first recovery path 24. The formation of the gas flow by the blowers 30, 32 causes the formation of the flow of gas passing from the intake unit 12 through at least one of the adsorption towers of the first treatment unit 20 and the second treatment unit 22 and flowing through the first recovery path 24 to the target space 8. Note that, in the present embodiment, the blower 30 is provided on the upstream side of the path through which gas flows and the blower 32 is provided on the downstream side thereof, but only one of the blower 30 and the blower 32 may be provided.

The vacuum pump 34 is disposed upstream from a connection point between the desorption path 26 and the second recovery path 27 (on the adsorption tower side). The vacuum pump 34 flows (suctions) gas in the desorption path 26 connected to the vacuum pump 34 toward the downstream side to depressurize a space located upstream from the connection point of the desorption path 26. In the carbon dioxide removal system 10 according to the present embodiment, the vacuum pump 34 is provided, but, when the outdoor space 6 is a space that is sufficiently lower in pressure than the target space 8, for example, a vacuum space, the vacuum pump 34 may not be provided. In this case, the space on the upstream side can be depressurized by opening or closing the valve 28a.

Next, the pipes and the valve in the flow path 14 will be described. In the first main path 42, a pipe that connects the upstream adsorption tower 50a to the midstream adsorption tower 52a is an intermediate path 56a; a pipe that connects the midstream adsorption tower 52a to the downstream adsorption tower 54a is an intermediate path 58a; and a pipe that connects the downstream adsorption tower 54a to the first recovery path 24 is an intermediate path 60a. A valve 70a is disposed in the first main path 42 between the intake path 40 and the upstream adsorption tower 50a. A valve 72a is disposed in the intermediate path 56a. A valve 74a is disposed closer to the midstream adsorption tower 52a than to the valve 72a in the intermediate path 56a. A valve 76a is disposed in the intermediate path 58a. A valve 78a is disposed closer to the downstream adsorption tower 54a than to the valve 76a in the intermediate path 58a. A valve 80a is disposed in the intermediate path 60a. That is, in the first main path 42, the valve 70a is disposed upstream from the upstream adsorption tower 50a and the valve 72a is disposed downstream from the upstream adsorption tower 50a. In the first main path 42, the valve 74a is disposed upstream from the midstream adsorption tower 52a and the valve 76a is disposed downstream from the midstream adsorption tower 52a. In the first main path 42, the valve 78a is disposed upstream from the downstream adsorption tower 54a and the valve 80a is disposed downstream from the downstream adsorption tower 54a.

In the second main path 44, a pipe that connects the upstream adsorption tower 50b to the midstream adsorption tower 52b is an intermediate path 56b; a pipe that connects the midstream adsorption tower 52b to the downstream adsorption tower 54b is an intermediate path 58b; and a pipe that connects the downstream adsorption tower 54b to the first recovery path 24 is an intermediate path 60b. A valve 70b is disposed in the second main path 44 between the intake path 40 and the upstream adsorption tower 50b. A valve 72b is disposed in the intermediate path 56b. A valve 74b is disposed closer to the midstream adsorption tower 52b than to the valve 72b in the intermediate path 56b. A valve 76b is disposed in the intermediate path 58b. A valve 78b is disposed closer to the downstream adsorption tower 54b than to the valve 76b in the intermediate path 58b. A valve 80b is disposed in the intermediate path 60b. That is, in the second main path 44, the valve 70b is disposed upstream from the upstream adsorption tower 50b and the valve 72b is disposed downstream from the upstream adsorption tower 50b. In the second main path 44, the valve 74b is disposed upstream from the midstream adsorption tower 52b and the valve 76b is disposed downstream from the midstream adsorption tower 52b. In the second main path 44, the valve 78b is disposed upstream from the downstream adsorption tower 54b and valve 80b is disposed downstream from the downstream adsorption tower 54b.

The branch pipe 100 connects a point between the valve 70a and the upstream adsorption tower 50a in the first main path 42 to a point between the valve 70b and the upstream adsorption tower 50b in the second main path 44. The branch pipe 102 connects a point between the valve 72a and the valve 74a in the intermediate path 56a to a point between the valve 72b and the valve 74b in the intermediate path 56b. The branch pipe 104 connects a point between the valve 72a and the valve 74a in the intermediate path 56a to a point between the valve 72b and the valve 74b in the intermediate path 56b. The branch pipe 106 connects a point between the valve 76a and the valve 78a in the intermediate path 58a to a point between the valve 76b and the valve 78b in the intermediate path 58b. The branch pipe 108 connects a point between the valve 76a and the valve 78a in the intermediate path 58a to a point between the valve 76b and the valve 78b in the intermediate path 58b. The branch pipe 110 connects a point between the downstream adsorption tower 54a and the valve 80a in the intermediate path 60a to a point between the downstream adsorption tower 54b and the valve 80b in the intermediate path 60b.

The connection path 112 connects the branch pipe 100 to the branch pipe 102. The connection path 114 connects the branch pipe 102 to the branch pipe 106. The connection path 114 connects to the desorption path 26. The connection path 116 connects the branch pipe 104 to a discharge pipe 24. Note that, in FIG. 1, the connection path 116 is connected downstream from the valve 80a to the intermediate path 60a, but is beneficially connected to the discharge pipe 24 not via any valve. The connection path 118 connects the branch pipe 106 to the branch pipe 110. The connection path 120 connects the branch pipe 108 to the discharge pipe 24.

A valve 101a is disposed closer to the first treatment unit 20 than to the connection path 112 in the connection pipe 100. A valve 101b is disposed closer to the second treatment unit 22 than to the connection path 112 in the connection pipe 100. A valve 103a is disposed closer to the first treatment unit 20 than to the connection path 112 and the connection path 114 in the connection pipe 102. A valve 103b is disposed closer to the second treatment unit 22 than to the connection path 112 and the connection path 114 in the connection pipe 102. A valve 105a is disposed closer to the first treatment unit 20 than to the connection path 116 in the connection pipe 104. A valve 105b is disposed closer to the second treatment unit 22 than to the connection path 116 in the connection pipe 104. A valve 107a is disposed closer to the first treatment unit 20 than to the connection path 114 and the connection path 118 in the connection pipe 106. A valve 107b is disposed closer to the second treatment unit 22 than to the connection path 114 and the connection path 118 in the connection pipe 106. A valve 109a is disposed closer to the first treatment unit 20 than to the connection path 120 in the connection pipe 108. A valve 109b is disposed closer to the second treatment unit 22 than to the connection path 120 in the connection pipe 108. A valve 111a is disposed closer to the first treatment unit 20 than to the connection path 118 in the connection pipe 110. A valve 111b is disposed closer to the second treatment unit 22 than to the connection path 118 in the connection pipe 110.

Here, the connection relationships and the valve arrangements in the flow path 14 in the present embodiment are merely examples. The flow path 14 is beneficially a path with the arrangement of valves so that adsorption towers configured to perform adsorption treatment and adsorption towers configured to perform discharge treatment can be switched as described below. As the valves, three-way valves may be used, for example. Alternatively, a control valve capable of adjusting the degree of opening as a switching mechanism may be used.

The control device 36 is a control device configured to control the carbon dioxide removal system 10. In the present embodiment, the control device 36 is a computer and includes: a processor including an arithmetic circuit such as a central processing unit (CPU); and a memory unit configured to store various types of information such as arithmetic contents performed by the processor and computer programs. The control device 36 controls the carbon dioxide removal system 10 by reading the computer programs from the memory unit.

The control device 36 controls the opening and closing of the valves provided in the flow path 14, the driving of the blowers 30, 32, and the driving of the vacuum pump 34 and thereby controls: adsorption treatment to adsorb carbon dioxide contained in the treatment target gas passing through the first treatment unit 20 and the second treatment unit 22 and thereby reduce or remove the carbon dioxide from the treatment target gas; and desorption treatment to reduce the pressure of the adsorption towers of the first treatment unit 20 and the second treatment unit 22 or reduce the pressure of the adsorption towers while increasing the temperature and thereby desorb the carbon dioxide adsorbed in the first treatment unit 20 and the second treatment unit 22 from the adsorption towers. The control device 36 switches between the adsorption towers to perform adsorption treatment and the adsorption towers to perform desorption treatment, based on settings inputted in advance and detected conditions.

The power source 38 supplies the constituents with electric power to drive the carbon dioxide removal system 10. The power source 38 includes a battery 38a and a solar generator 38b. The battery 38a accumulates electric power generated by the solar generator 38b. The battery 38a supplies the accumulated electric power to the constituents. The solar generator 38b generates electric power with energy supplied from the sun. The solar generator 38b supplies the generated electric power to the constituents and the battery 38a.

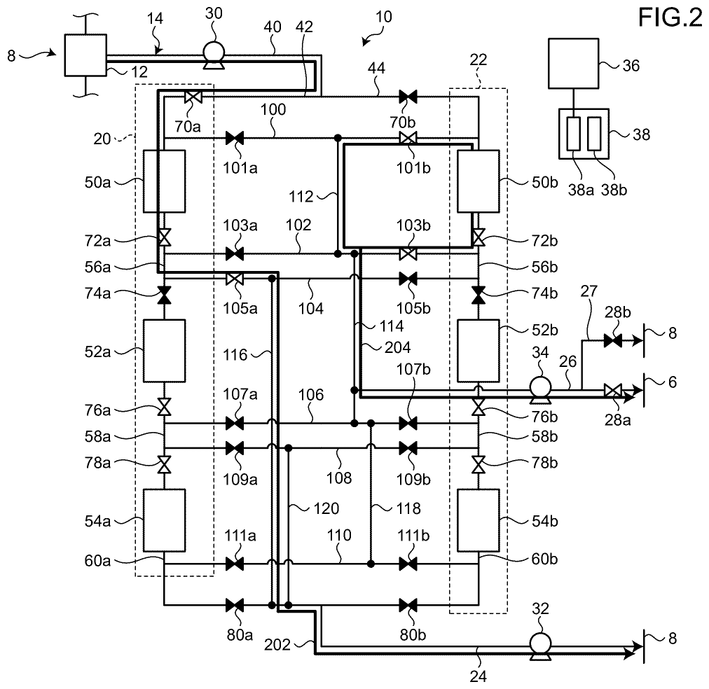

Next, the operation of the carbon dioxide removal system according to the present embodiment, that is, adsorption treatment and desorption treatment will be described using FIG. 2 to FIG. 10. FIG. 2 to FIG. 10 are diagrams each illustrating an example of the operation of the carbon dioxide removal system according to the present embodiment.

In the carbon dioxide removal system 10 according to the present embodiment, each of the first treatment unit 20 and the second treatment unit 22 includes a plurality of adsorption towers and the adsorption towers are connected in series. The carbon dioxide removal system 10 can switch the number of adsorption towers through which the treatment target gas passes by switching the flow path of the treatment target gas. Furthermore, the carbon dioxide removal system 10 can switch the number of adsorption towers that perform desorption treatment.

The carbon dioxide removal system 10 illustrated in FIG. 2 performs adsorption treatment in the upstream adsorption tower 50a of the first treatment unit 20 and performs desorption treatment in the upstream adsorption tower 50b of the second treatment unit 22. For the adsorption treatment, the control device 36 opens the valve 70a, the valve 72a, and the valve 105a, and closes the valve 70b, the valve 101a, the valve 103a, the valve 74a, the valve 105b, the valve 109a, the valve 109b, the valve 80a, and the valve 80b. Thus, the treatment target gas flows through a path 202 passing through only the upstream adsorption tower 50a of the first treatment unit 20 and not passing through other adsorption towers. For the desorption treatment, the control device 36 opens the valve 72b, the valve 101b, the valve 103b, and the valve 28a, and closes the valve 70b, the valve 101a, the valve 103a, the valve 105b, the valve 74b, the valve 107a, the valve 107b, the valve 111a, the valve 111b, and the valve 28b. Thus, a path 204 in which only the upstream adsorption tower 50b of the second treatment unit 22 is depressurized by the vacuum pump 34 is formed.

In the carbon dioxide removal system 10, the treatment units each include a plurality of divided adsorption towers, so that each of the adsorption towers can be shorter in length, a pressure loss in each of the adsorption towers can be smaller, the degree of vacuum can be increased, and desorption performance can be maintained high. The carbon dioxide removal system 10 can be configured in such a manner that both a path on the upstream side of the adsorption tower that performs desorption treatment and a path on the downstream side thereof can be connected to a path provided with the vacuum pump 34, whereby the adsorption towers can perform adsorption treatment in parallel.

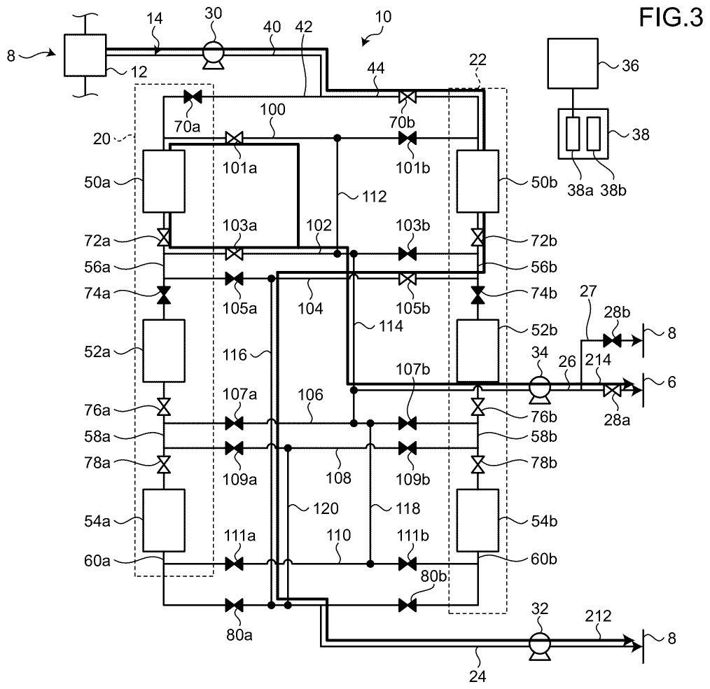

The carbon dioxide removal system 10 illustrated in FIG. 3 performs adsorption treatment in the upstream adsorption tower 50b of the second treatment unit 22 and performs desorption treatment in the upstream adsorption tower 50a of the first treatment unit 20. For the adsorption treatment, the control device 36 opens the valve 70b, the valve 72b, and the valve 105b, and closes the valve 70a, the valve 101b, the valve 103b, the valve 74b, the valve 105a, the valve 109a, the valve 109b, the valve 80b, and the valve 80a. Thus, the treatment target gas flows through a path 212 passing through only the upstream adsorption tower 50b of the second treatment unit 22 and not passing through other adsorption towers. For the desorption treatment, the control device 36 opens the valve 72a, the valve 101a, the valve 103a, and the valve 28a, and closes the valve 70a, the valve 101b, the valve 103b, the valve 105a, the valve 74a, the valve 107a, the valve 107b, the valve 111a, the valve 111b, and the valve 28b. Thus, a path 214 in which only the upstream adsorption tower 50a of the first treatment unit 20 is depressurized by the vacuum pump 34 is formed.

The carbon dioxide removal system 10 switches between a treatment mode illustrated in FIG. 2 and a treatment mode illustrated in FIG. 3 at predetermined intervals, and thereby can switch between a mode of performing adsorption treatment in the first treatment unit 20 and performing desorption treatment in the second treatment unit 22 and a mode of performing desorption treatment in the first treatment unit 20 and performing adsorption treatment in the second treatment unit 22. In addition, when adsorption treatment and desorption treatment are performed by one of the adsorption towers in each of the treatment units, the amount of electric power used can be reduced compared to when adsorption treatment and desorption treatment are performed by all of the adsorption towers in each of the treatment units. In addition, the time for desorption treatment can be shortened.

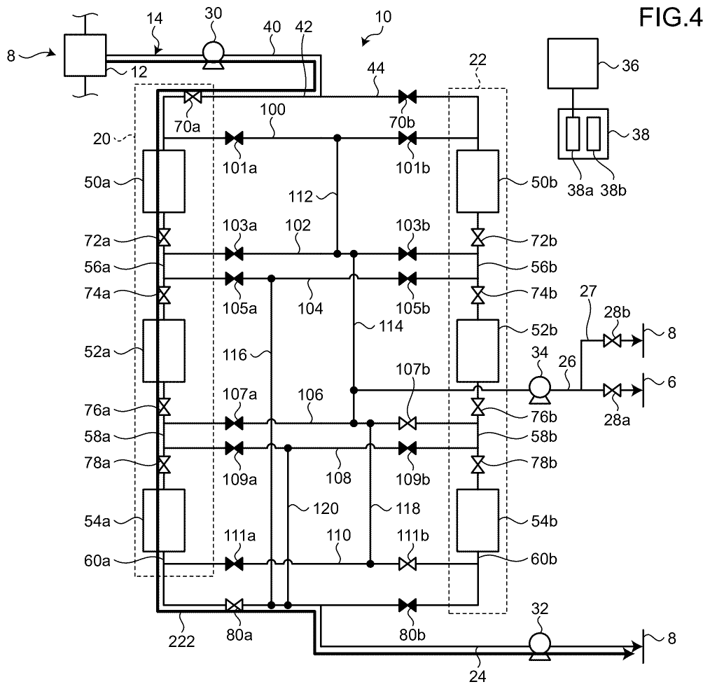

The carbon dioxide removal system 10 illustrated in FIG. 4 performs adsorption treatment in the upstream adsorption tower 50a, the midstream adsorption tower 52a, and the downstream adsorption tower 54a of the first treatment unit 20. The carbon dioxide removal system 10 illustrated in FIG. 4 does not perform desorption treatment simultaneously with the adsorption treatment. For the adsorption treatment, the control device 36 opens the valve 70a, the valve 72a, the valve 74a, the valve 76a, the valve 78a, and the valve 80a, and closes the valve 70b, the valve 101a, the valve 101b, the valve 103a, the valve 103b, the valve 105a, the valve 105b, the valve 107a, the valve 109a, the valve 109b, the valve 111a, and the valve 80b. Thus, the treatment target gas flows through a path 222 passing through all of the upstream adsorption tower 50a, the midstream adsorption tower 52a, and the downstream adsorption tower 54a of the first treatment unit 20.

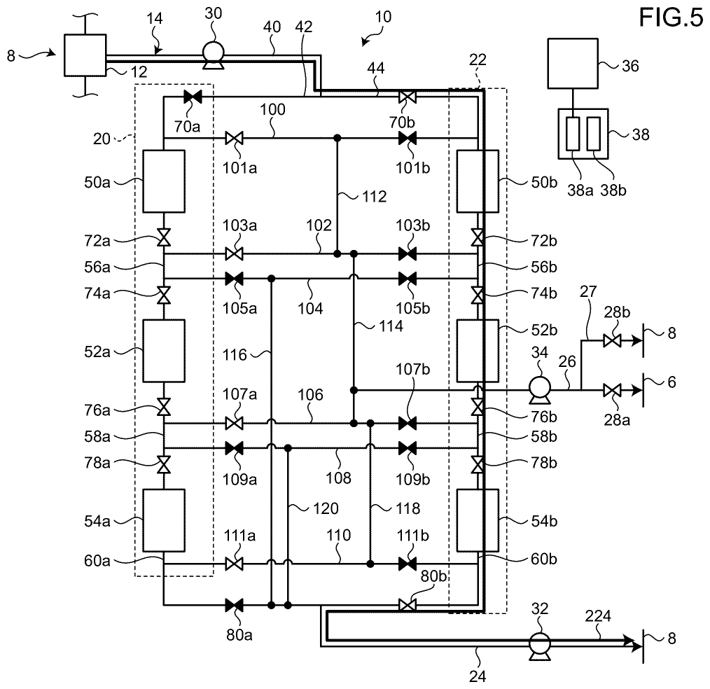

The carbon dioxide removal system 10 illustrated in FIG. 5 performs adsorption treatment in the upstream adsorption tower 50b, the midstream adsorption tower 52b, and the downstream adsorption tower 54b of the second treatment unit 22. The carbon dioxide removal system 10 illustrated in FIG. 5 does not perform desorption treatment simultaneously with the adsorption treatment. For the adsorption treatment, the control device 36 opens the valve 70b, the valve 72b, the valve 74b, the valve 76b, the valve 78b, and the valve 80b, and closes the valve 70a, the valve 101b, the valve 103b, the valve 105a, the valve 105b, the valve 107b, the valve 109a, the valve 109b, the valve 111b, and the valve 80a. Thus, the treatment target gas flows through a path 224 passing through all of the upstream adsorption tower 50b, the midstream adsorption tower 52b, and the downstream adsorption tower 54b of the second treatment unit 22.

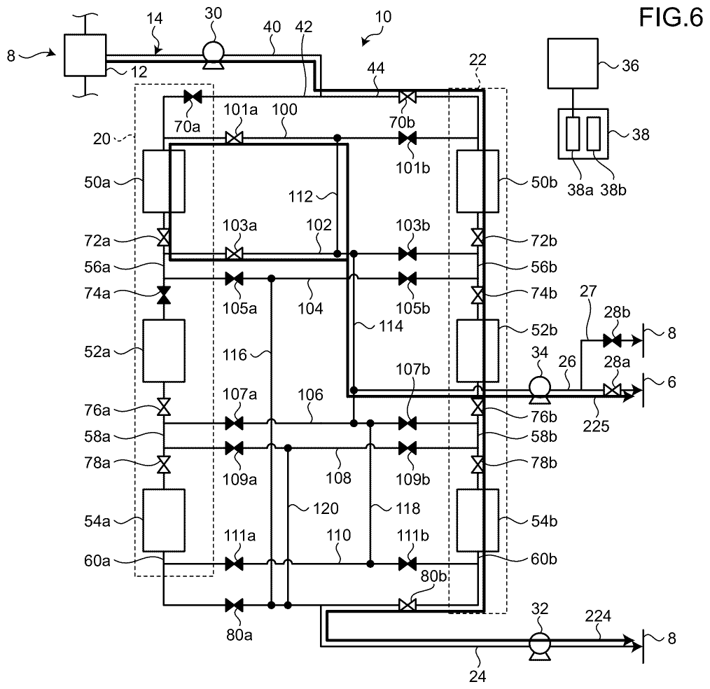

The carbon dioxide removal system 10 illustrated in FIG. 6 performs adsorption treatment in the upstream adsorption tower 50b, the midstream adsorption tower 52b, and the downstream adsorption tower 54b of the second treatment unit 22, and performs desorption treatment in the upstream adsorption tower 50a of the first treatment unit 20. For the adsorption treatment, the control device 36 opens the valve 70b, the valve 72b, the valve 74b, the valve 76b, the valve 78b, and the valve 80b, and closes the valve 70a, the valve 101b, the valve 103b, the valve 105a, the valve 105b, the valve 107b, the valve 109a, the valve 109b, the valve 111b, and the valve 80a. Thus, the treatment target gas flows through the path 224 passing through all of the upstream adsorption tower 50b, the midstream adsorption tower 52b, and the downstream adsorption tower 54b of the second treatment unit 22. For the desorption treatment, the control device 36 opens the valve 72a, the valve 101a, the valve 103a, and the valve 28a, and closes the valve 70a, the valve 101b, the valve 103b, the valve 105a, the valve 74a, the valve 107a, the valve 107b, the valve 111a, the valve 111b, and the valve 28b. Thus, a path 225 in which the upstream adsorption tower 50a of the first treatment unit 20 is depressurized by the vacuum pump 34 is formed.

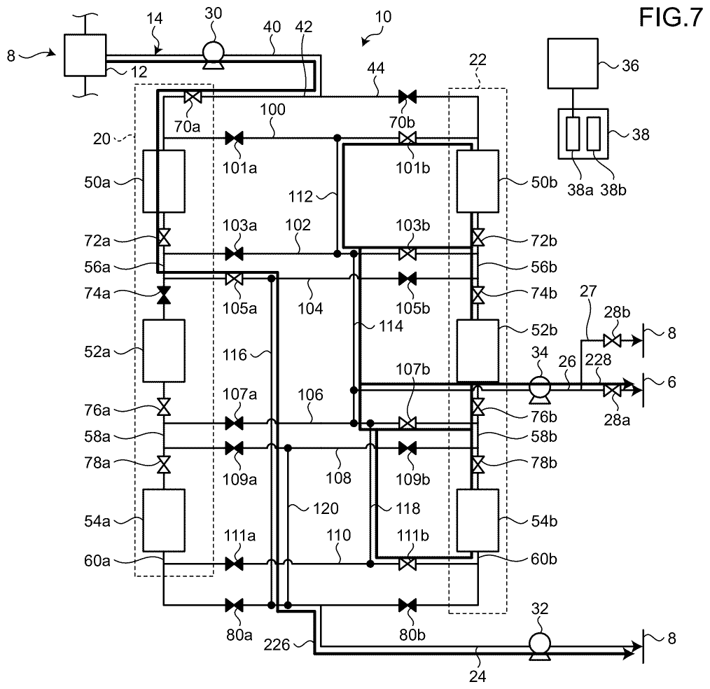

The carbon dioxide removal system 10 illustrated in FIG. 7 performs adsorption treatment in the upstream adsorption tower 50a of the first treatment unit 20 and performs desorption treatment in the upstream adsorption tower 50b, the midstream adsorption tower 52b, and the downstream adsorption tower 54b of the second treatment unit 22. For the adsorption treatment, the control device 36 opens the valve 70a, the valve 72a, and the valve 105a, and closes the valve 70b, the valve 101a, the valve 103a, the valve 74a, the valve 105b, the valve 109a, the valve 109b, the valve 80a, and the valve 80b. Thus, the treatment target gas flows through a path 226 passing through only the upstream adsorption tower 50a of the first treatment unit 20 and not passing through other adsorption towers. For the desorption treatment, the control device 36 opens the valve 72b, the valve 74b, the valve 76b, the valve 78b, the valve 101b, the valve 103b, the valve 107b, the valve 111b, and the valve 28a, and closes the valve 70b, the valve 101a, the valve 103a, the valve 105b, the valve 107a, the valve 109b, the valve 111a, the valve 80b, and the valve 28b. Thus, a path 228 in which the upstream adsorption tower 50b, the midstream adsorption tower 52b, and the downstream adsorption tower 54b of the second treatment unit 22 are depressurized by the vacuum pump 34 is formed.

The carbon dioxide removal system 10 executes the treatment mode illustrated in FIG. 4, then executes the treatment mode illustrated in FIG. 5, then the treatment mode illustrated in FIG. 6, and then the treatment mode illustrated in FIG. 7. After executing the treatment mode illustrated in FIG. 7, the carbon dioxide removal system 10 preferably performs adsorption treatment in the upstream adsorption tower 50b of the second treatment unit 22 and performs desorption treatment in the upstream adsorption tower 50a, the midstream adsorption tower 52a, and the downstream adsorption tower 54a of the first treatment unit 20.

The carbon dioxide removal system 10 executes the above-described modes, and, without performing desorption treatment in the treatment unit in which adsorption treatment is not performed, the carbon dioxide removal system 10 performs adsorption treatment by using all the adsorption towers of each of the treatment units, and then performs desorption treatment. Thus, power consumption in the mode of performing adsorption treatment by using all the adsorption towers of each of the treatment units can be reduced, meanwhile treatment for removing carbon dioxide from the treatment target gas can be performed over a longer period of time. The use of all of the adsorption towers of the treatment units leads to an increase in the amount of the treatment target gas kept in the system, whereby the carbon dioxide removal system 10 can perform the removal treatment over a longer period of time. As illustrated in FIG. 6, the adsorption treatment can be performed by all of the adsorption towers of one of the treatment units meanwhile the desorption treatment can be performed by one of the adsorption towers of the other one of the treatment units is performed, whereby, while reducing an increase in power consumption, the adsorption tower to be used for the next mode can be prepared. For example, when an environment in which the use of electric power is limited remains for a predetermined time even after the adsorption treatment is performed by all the adsorption towers, only the minimum number of the adsorption towers to perform the adsorption treatment for that predetermined time performs desorption for the preparation. This reduces power consumption needed to prepare the adsorption tower to be used for the next mode. When electric power becomes available, desorption treatment is performed in the adsorption towers simultaneously, as illustrated in FIG. 7, whereby the number of the adsorption towers available can be increased in a short time.

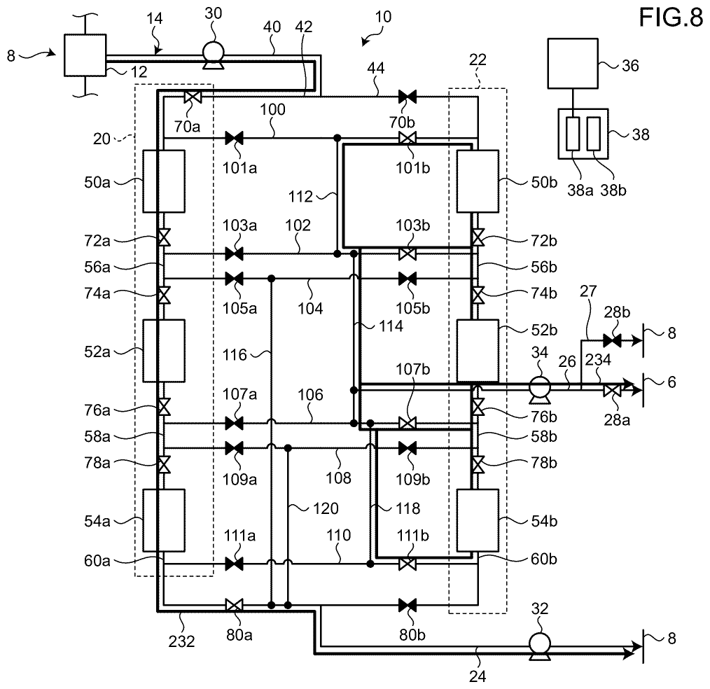

The carbon dioxide removal system 10 illustrated in FIG. 8 performs adsorption treatment in the upstream adsorption tower 50a, the midstream adsorption tower 52a, and the downstream adsorption tower 54a of the first treatment unit 20, and performs desorption treatment in the upstream adsorption tower 50b, the midstream adsorption tower 52b, and the downstream adsorption tower 54b of the second treatment unit 22. For the adsorption treatment, the control device 36 opens the valve 70a, the valve 72a, the valve 74a, the valve 76a, the valve 78a, and the valve 80a, and closes the valve 70b, the valve 101a, the valve 103a, the valve 105a, the valve 105b, the valve 107a, the valve 109a, the valve 109b, the valve 111a, and the valve 80b. Thus, the treatment target gas flows through a path 232 passing through the upstream adsorption tower 50a, the midstream adsorption tower 52a, and the downstream adsorption tower 54a of the first treatment unit 20. For the desorption treatment, the control device 36 opens the valve 72b, the valve 74b, the valve 76b, the valve 78b, the valve 101b, the valve 103b, the valve 107b, the valve 111b, and the valve 28a, and closes the valve 70b, the valve 101a, the valve 103a, the valve 105b, the valve 107a, the valve 109b, the valve 111a, the valve 80b, and the valve 28b. Thus, a path 234 in which the upstream adsorption tower 50b, the midstream adsorption tower 52b, and the downstream adsorption tower 54b of the second treatment unit 22 are depressurized by the vacuum pump 34 is formed.

After executing the treatment mode illustrated in FIG. 8, the carbon dioxide removal system 10 preferably interchanges adsorption treatment with desorption treatment, that is, preferably performs adsorption treatment in the upstream adsorption tower 50b, the midstream adsorption tower 52b, and the downstream adsorption tower 54b of the second treatment unit 22 and performs desorption treatment in the upstream adsorption tower 50a, the midstream adsorption tower 52a, and the downstream adsorption tower 54a of the first treatment unit 20.

As illustrated in FIG. 8, the carbon dioxide removal system 10 performs adsorption treatment in all the adsorption towers of one of the treatment units and performs desorption treatment in all the adsorption towers of the other one of the treatment units, and thereby can remove more amount of carbon dioxide from the treatment target gas. The carbon dioxide removal system 10 can be configured in such a manner that both a path on the upstream side of the adsorption tower configured to perform desorption treatment and a path on the downstream side thereof can be connected to a path provided with the vacuum pump 34, whereby the adsorption towers disposed in series in the main path can perform the desorption treatment in parallel. Thus, the carbon dioxide removal system 10 can perform adsorption treatment in the adsorption towers disposed in series and perform desorption treatment in parallel for the adsorption towers connected in series. When the amount of electric power used is not limited or when the concentration of carbon dioxide in the treatment target gas is high, the carbon dioxide removal system 10 preferably performs treatment in the mode illustrated in FIG. 8.

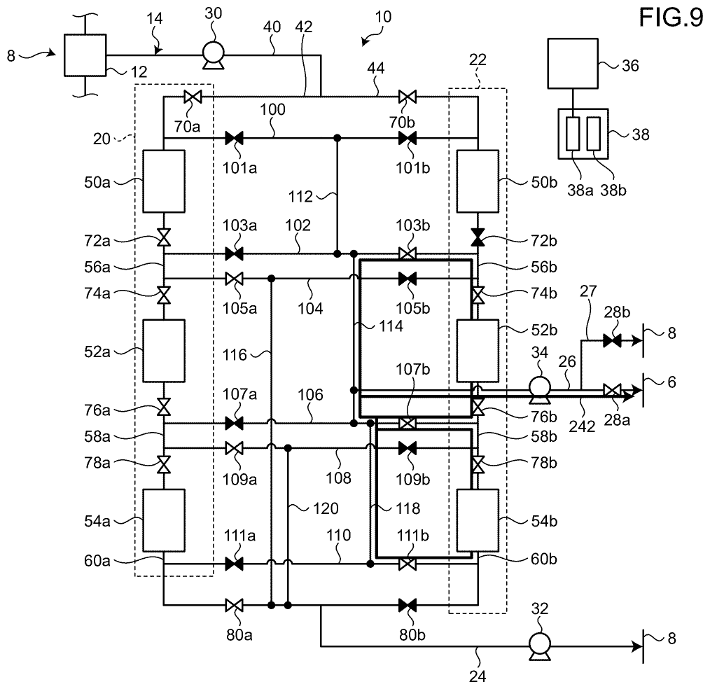

The carbon dioxide removal system 10 illustrated in FIG. 9 performs desorption treatment in the midstream adsorption tower 52b and the downstream adsorption tower 54b of the second treatment unit 22 and does not perform desorption treatment in the upstream adsorption tower 50b of the second treatment unit. In the mode illustrated in FIG. 9, adsorption treatment may or may not be performed in the first treatment unit 20 simultaneously with the desorption treatment. For the desorption treatment, the control device 36 opens the valve 74b, the valve 76b, the valve 78b, the valve 103b, the valve 107b, the valve 111b, and the valve 28a, and closes the valve 72b, the valve 101a, the valve 101b, the valve 103a, the valve 105b, the valve 107a, the valve 109b, the valve 111a, the valve 80b, and the valve 28b. Thus, a path 242 in which the midstream adsorption tower 52b and the downstream adsorption tower 54b of the second treatment unit 22 are depressurized by the vacuum pump 34 is formed.

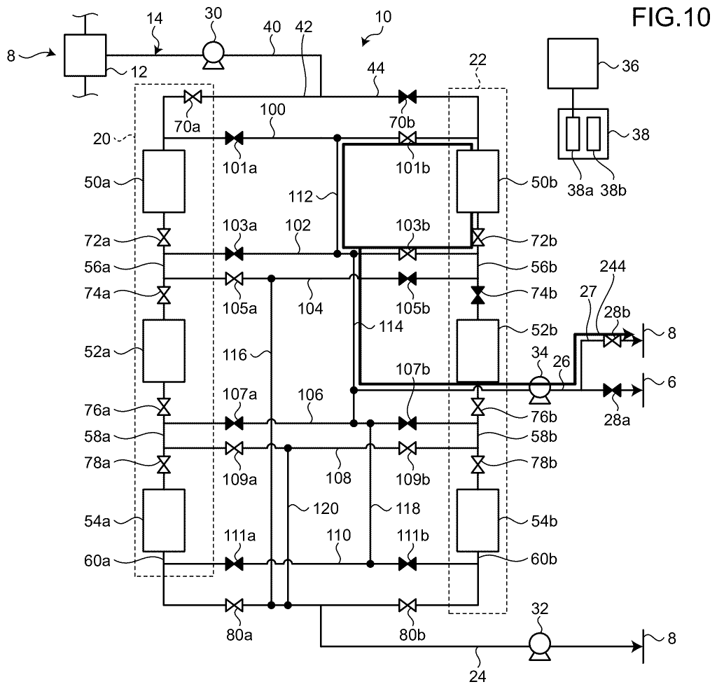

The carbon dioxide removal system 10 illustrated in FIG. 10 performs desorption treatment in the upstream adsorption tower 50a of the second treatment unit 22 and does not perform in the midstream adsorption tower 52b and the downstream adsorption tower 54b of the second treatment unit 22. In the mode illustrated in FIG. 10, adsorption treatment may or may not be performed in the first treatment unit 20 simultaneously with the desorption treatment. For the desorption treatment, the control device 36 opens the valve 72b, the valve 101b, the valve 103b, and the valve 28b, and closes the valve 70b, the valve 74b, the valve 101a, the valve 103a, the valve 105b, the valve 107a, the valve 107b, the valve 111a, the valve 111b, and the valve 28a. Thus, a path 244 in which the upstream adsorption tower 50b of the second treatment unit 22 is depressurized by the vacuum pump 34 and the treated gas is supplied from the second recovery path 27 to the target space 8 is formed.

The carbon dioxide removal system 10 can perform the desorption treatment illustrated in FIG. 9 and FIG. 10 also in the first treatment unit 20. When the carbon dioxide removal system 10 uses a material that adsorbs moisture as an adsorbent, moisture adsorbed during desorption is desorbed and discharged together with carbon dioxide, which results in a decrease in the humidity of the target space. When an amine-impregnated adsorbent or the like is used, moisture tends to be preferentially adsorbed in the upstream adsorption tower and accordingly the amount of carbon dioxide adsorbed tends to be reduced meanwhile carbon dioxide tends to be mainly adsorbed in the downstream adsorption tower. In this case, the carbon dioxide removal system 10 returns the moisture adsorbed in the upstream adsorption tower to the target space 8. Furthermore, carbon dioxide adsorbed in adsorption towers on the downstream side, namely, the midstream adsorption tower and the downstream adsorption tower, is desorbed from the desorption path 26, whereby carbon dioxide can be removed from the target space.

As described above, the carbon dioxide removal system 10 includes a plurality of adsorption towers disposed in series and can switch between paths, and thereby can perform treatment according to a situation. When adsorption treatment and desorption treatment can be performed by one adsorption tower, the adsorption treatment and the desorption treatment can be performed with a small pressure loss, and the adsorption treatment and the desorption treatment can be performed with smaller power consumption, and power consumption can be leveled out. In addition, when desorption treatment can be performed in parallel, the desorption treatment can be performed with a small pressure loss, and the number of the adsorption towers available can be increased in a shorter time. In addition, the adsorption treatment performed by a plurality of adsorption towers connected in series can use the adsorption towers continuously for a longer period of time than the adsorption treatment performed by one adsorption tower.

Compared to depressurizing an integrated long adsorption tower, the carbon dioxide removal system 10 according to the embodiment allows both paths on the upstream and downstream sides of each of divided adsorption towers to be connected to a vacuum pump, whereby an adsorbent pressure loss in the adsorption tower can be reduced and the ultimate pressure obtained when the adsorption tower is depressurized can be reduced, and the desorption of carbon dioxide can be suitably performed.

In the carbon dioxide removal system 10, the adsorption towers may include a heater, and the adsorption tower that performs desorption treatment may be heated with the heater. The heating allows carbon dioxide desorption treatment to be completed in a short time. The carbon dioxide removal system 10 preferably does not perform heating under the condition in which power consumption needs to be reduced, because power consumption is caused by the heating.

In the present embodiment, three adsorption towers are provided for one treatment unit, but the number of the adsorption towers is not limited as long as two or more adsorption towers are connected in series. In other words, four adsorption towers may be disposed in series. When two or more adsorption towers are connected in series and the number of adsorption towers through which the treatment target gas flows can be changed, carbon dioxide removal treatment can be performed according to situations. Alternatively, in the present embodiment, two units, namely, the first treatment unit 20 and the second treatment unit 22 are disposed in parallel, but three or more units may be disposed.

The carbon dioxide removal system 10 can suitably remove carbon dioxide by switching between the modes illustrated in FIG. 2 to FIG. 10, based on a schedule predetermined by an operator. The treatment can be performed with reduced power consumption as necessary, and, when the amount of electric power used is not limited, the desorption treatment can be performed in a short time. The carbon dioxide removal system 10 may determine a mode to be executed, based on the concentration of carbon dioxide in the target space 8, persons in the target space 8, information on action schedule, the prediction of power generation of a power source, and the amount of electric power remaining.

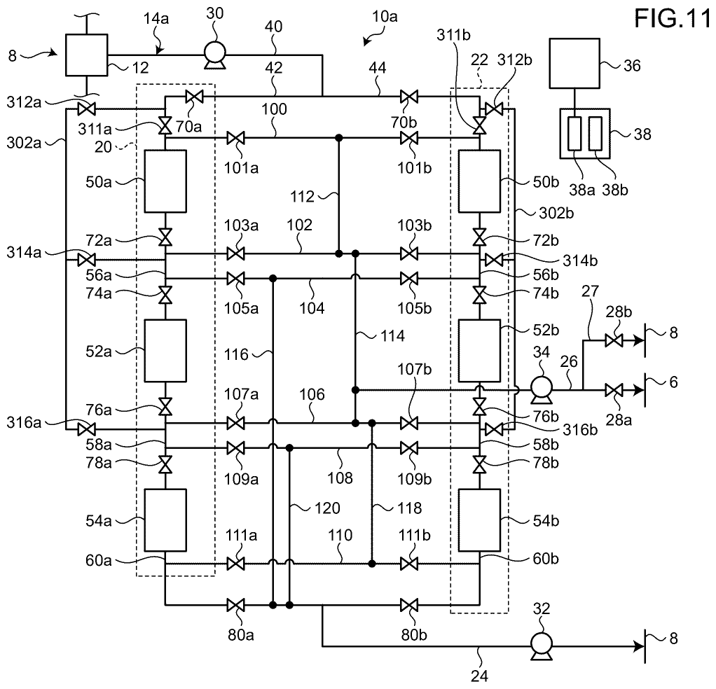

FIG. 11 is a schematic diagram of a carbon dioxide removal system in another embodiment. A carbon dioxide removal system 10a illustrated in FIG. 11 is the same as the carbon dioxide removal system 10 illustrated in FIG. 1, except for the structure of a flow path 14a. Hereinafter, distinct features of the carbon dioxide removal system 10a will be described. The flow path 14a includes switching paths 302a, 302b.

The switching path 302a includes branches connected to respective pipes on the upstream side of an upstream adsorption tower 50a, a midstream adsorption tower 52a, and a downstream adsorption tower 54a of the first main path 42. A valve 311a is disposed between a connection point of the first main path 42 to the switching path 302a and the upstream adsorption tower 50a. A valve 312a is disposed at the branch connected to a point between the valve 70a of the first main path 42 and the upstream adsorption tower 50a. A valve 314a is disposed at the branch connected to a point between the valve 72a and the valve 74a of the intermediate path 56a. A valve 316a is disposed at the branch connected to a point between the valve 76a and the valve 78a of the intermediate path 58a.

The switching path 302b includes branches connected to respective pipes on the upstream side of the upstream adsorption tower 50b, the midstream adsorption tower 52b, and the downstream adsorption tower 54b of the second main path 44. A valve 311b is disposed between a connection point of the second main path 44 to the switching path 302b and the upstream adsorption tower 50b. A valve 312b is disposed at the branch connected to a point between the valve 70b of the second main path 44 and the upstream adsorption tower 50b. A valve 314b is disposed at the branch connected to a point between the valve 72b and the valve 74b of the intermediate path 56b. A valve 316b is disposed at the branch connected to a point between the valve 76b and the valve 78b of the intermediate path 58b.

The provision of the carbon dioxide removal system 10a and the switching paths 302, 304 allows switching the adsorption towers used in each of the treatment units.

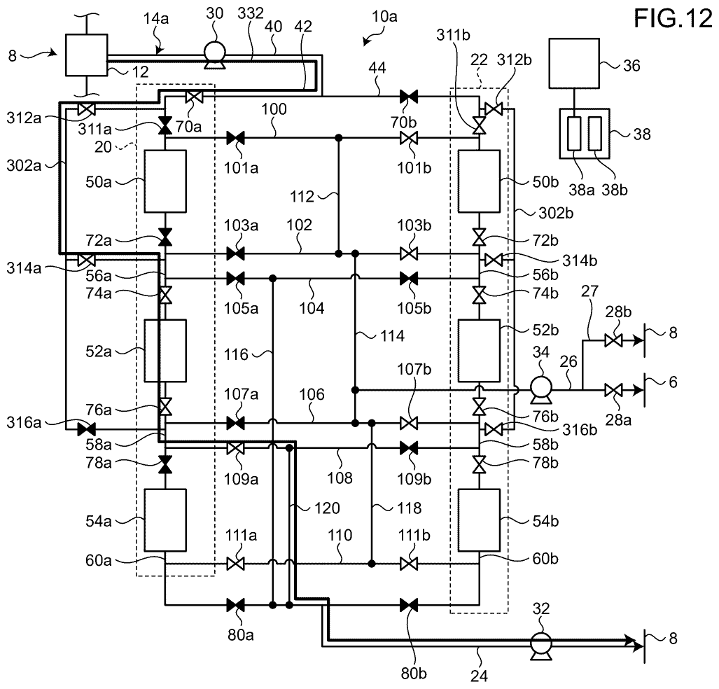

FIG. 12 is an explanatory diagram illustrating an operation example of the carbon dioxide removal system illustrated in FIG. 11. The carbon dioxide removal system 10a illustrated in FIG. 12 performs adsorption treatment in the midstream adsorption tower 52a of the first treatment unit 20 and does not perform adsorption treatment in the upstream adsorption tower 50a and the downstream adsorption tower 54a of the first treatment unit 20. For the adsorption treatment, the control device 36 opens the valve 70a, the valve 312a, the valve 314a, the valve 74a, the valve 76a, and the valve 109a, and closes the valve 70b, the valve 311a, the valve 72a, the valve 316a, the valve 103a, the valve 105a, the valve 105b, the valve 107a, the valve 78a, the valve 109b, the valve 80a, and the valve 80b. Thus, the treatment target gas flows through a path 332 passing through the midstream adsorption tower 52a of the first treatment unit 20 and not passing through the upstream adsorption tower 50a and the downstream adsorption tower 54a of the first treatment unit 20. The carbon dioxide removal system 10a opens the valves 312a, 316a, closes the valve 314a, and switches other valves as appropriate, and thereby can form a path passing through the downstream adsorption tower 54a of the first treatment unit 20 and not passing through the upstream adsorption tower 50a and the midstream adsorption tower 52b of the first treatment unit 20. The adsorption treatment in the second treatment unit 22 is the same as above. Alternatively the path can be changed so as to pass through two of the three adsorption towers.

The carbon dioxide removal system 10a includes the switching paths 302, 304 and whereby adsorption treatment can be performed only in the midstream adsorption tower or only in the downstream adsorption tower. Thus, more available modes are made, that is, more combinations of adsorption towers to be used can be realized. Thus, treatment can be performed in a more suitable mode according to a situation. Furthermore, even when an operation is performed with only one adsorption tower, the degree of degradation of an adsorbent can be equalized by evenly using the upstream adsorption tower, the midstream adsorption tower, and the downstream adsorption tower, which results in stable performance.

### Effects of the Present Disclosure

The present disclosure has the following features. Note that the present disclosure is not limited by the following.
(1) A carbon dioxide removal system, including:
   a treatment target gas acquisition unit configured to acquire a treatment target gas from a target space;
   a flow path configured to allow the acquired treatment target gas to flow through the flow path;
   a treatment unit including two or more adsorption towers connected in series in the flow path along a flow of the treatment target gas; and
   a control device configured to switch between paths of the treatment target gas, in which
   the flow path includes:
      a first main path configured to supply the treatment target gas to the treatment unit;
      a first recovery path configured to discharge, to the target space, the treatment target gas passed through the first main path;
      a desorption path connected to the adsorption towers to be depressurized;
      a first branch path configured to connect a path between the adsorption tower on an upstream side of the first treatment unit and the adsorption tower on a downstream side of the first treatment unit to the first recovery path; and
      a switching mechanism configured to switch a path through which the treatment target gas flows, and
   the desorption path is connectable in parallel to the plurality of adsorption towers.
(2) The carbon dioxide removal system according to (1), in which the desorption path is connectable to the upstream side and the downstream side of the adsorption towers.
(3) The carbon dioxide removal system according to (1) or (2), in which the control device controls the switching mechanism disposed in the flow path and is capable of selecting a mode of forming a path connecting the desorption path to all the adsorption towers of the treatment unit and depressurizing all the adsorption towers or a mode of forming a path connecting the desorption path to only one of the adsorption towers and depressurizing only the one adsorption tower.
(4) The carbon dioxide removal system according to any one of (1) to (3), in which the adsorption towers are filled with an amine-impregnated adsorbent.
(5) The carbon dioxide removal system according to (4), in which
   the desorption path includes a second recovery path connected to the target space, and
   the control device supplies, from the second recovery path to the target space, the treatment target gas recovered by depressurizing the adsorption tower on the upstream side.
(6) The carbon dioxide removal system according to any one of (1) to (5), in which
   the adsorption towers include a heater, and,
   when desorption treatment is performed for a substance adsorbed by the adsorption tower, the control device increases a temperature of the target adsorption tower with the heater.
(7) A carbon dioxide removal system, comprising:
   a treatment target gas acquisition unit configured to acquire a treatment target gas from a target space;
   a flow path configured to allow the acquired treatment target gas to flow through the flow path;
   a first treatment unit including two or more adsorption towers connected in series in the flow path along a flow of the treatment target gas;
   a second treatment unit
      including two or more adsorption towers connected in series in the flow path along a flow of the treatment target gas and
      disposed in parallel to the first treatment unit; and
   a control device configured to switch between paths of the treatment target gas, in which
   the flow path includes:
      a first main path configured to supply the treatment target gas to the first treatment unit;
      a second main path disposed in parallel to the first main path and configured to supply the treatment target gas to the second treatment unit;
      a first recovery path configured to discharge, to the target space, the treatment target gas passed through the first main path and the second main path;
      a desorption path connected to the adsorption towers to be depressurized;
      a first branch path configured to connect a path between the adsorption tower on an upstream side of the first treatment unit and the adsorption tower on a downstream side of the first treatment unit to the first recovery path; and
      a switching mechanism configured to switch a path through which the treatment target gas flows, and
   the control device controls the switching mechanism disposed in the flow path and is capable of switching between a mode of flowing the treatment target gas through all the adsorption towers of the first treatment unit and a mode of flowing the treatment target gas through the first branch path to allow the treatment target gas to flow through the adsorption tower disposed on the upstream side of the first treatment unit and not to allow the treatment target gas to flow through the adsorption tower disposed on the downstream side of the first treatment unit.
(8) The carbon dioxide removal system according to (7), in which
   the flow path includes a second branch path configured to connect a path between the adsorption tower disposed on an upstream side of the second treatment unit and the adsorption tower disposed on a downstream side of the second treatment unit to the first recovery path, and
   the control device is capable of selecting a mode of flowing the treatment target gas to all the adsorption towers of the second treatment unit or a mode of flowing the treatment target gas through the second branch path to allow the treatment target gas to flow through the adsorption tower disposed on the upstream side of the second treatment unit and not to allow the treatment target gas to flow through the adsorption tower disposed on the downstream side of the second treatment unit.
(9) The carbon dioxide removal system according to (7) or (8), in which
   the first branch path includes a path connected to the first main path, upstream from the adsorption tower disposed on the upstream side, and
   the control device is capable of selecting a mode of flowing the treatment target gas through the first branch path to allow the treatment target gas to flow through the adsorption tower disposed on the downstream side of the first treatment unit and not to allow the treatment gas to flow through the adsorption tower disposed on the upstream side.
(10) The carbon dioxide removal system according to any one of (7) to (9), in which
   the desorption path is connected to the upstream side and the downstream side of the adsorption towers, and
   the control device is capable of further selecting, as a switching target mode, a mode of forming a path configured to connect the desorption path to only one of the adsorption towers and depressurizing only the one adsorption tower.
(11) The carbon dioxide removal system according to any one of (7) to (10), in which
   the control device simultaneously performs adsorption processing of supplying the treatment target gas to at least one of the adsorption towers of the first treatment unit and the second treatment unit and desorption processing of connecting the adsorption tower to which the treatment target gas is not supplied to the desorption path to desorb an adsorbed substance.
(12) The carbon dioxide removal system according to any one of (7) to (11), wherein the adsorption towers are filled with an amine-impregnated adsorbent.
(13) The carbon dioxide removal system according to (12), in which
   the desorption path includes a second recovery path connected to the target space, and
   the control device supplies, from the second recovery path to the target space, the treatment target gas recovered by depressurizing the adsorption tower on the upstream side.
(14) The carbon dioxide removal system according to any one of (7) to (13), wherein
   the adsorption towers include a heater, and,
   when desorption treatment is performed for a substance adsorbed by the adsorption tower, the control device increases a temperature of the target adsorption tower with the heater.

### REFERENCE SIGNS LIST

6 Outdoor space
8 Target space
10 Carbon dioxide removal system
12 Intake unit (treatment target gas acquisition unit)
14 Flow path
20 First treatment unit
22 Second treatment unit
24 First recovery path
26 Desorption path
27 Second recovery path
28a, 28b Valve
30, 32 Blower
34 Vacuum pump
36 Control device
38 Power source
38a Battery
38b Solar generator
40 Intake path
42 First main path
44 Second main path
50a, 50b Upstream adsorption tower
52a, 52b Midstream adsorption tower
54a, 54b Downstream adsorption tower
56a, 56b, 58a, 58b, 60a, 60b Intermediate path
70a, 70b, 72a, 72b, 74a, 74b, 76a, 76b, 78a, 78b, 80a, 80b, 101a, 101b, 103a,
103b, 105a, 105b, 107a, 107b, 109a, 109b, 111a, 111b Valve
100, 102, 104, 106, 108, 110 Branch path

1. A carbon dioxide removal system, comprising:
a treatment target gas acquisition unit that acquires a treatment target gas from a target space;
a flow path that allows the acquired treatment target gas to flow through the flow path;
a treatment unit that includes two or more adsorption towers connected in series in the flow path along a flow of the treatment target gas; and
a control device that switches between paths of the treatment target gas, wherein
the flow path includes:
a first main path that supplies the treatment target gas to the treatment unit;
a first recovery path that discharges, to the target space, the treatment target gas passed through the first main path;
a desorption path that is connected to the adsorption towers to be depressurized;
a first branch path that connects a path between the adsorption tower on an upstream side of the treatment unit and the adsorption tower on a downstream side of the first treatment unit to the first recovery path; and
a switching mechanism that switches a path through which the treatment target gas flows, and
the desorption path is connectable in parallel to the plurality of adsorption towers.

2. The carbon dioxide removal system according to claim 1, wherein the desorption path is connectable to the upstream side and the downstream side of the adsorption towers.

3. The carbon dioxide removal system according to claim 1, wherein the control device controls the switching mechanism disposed in the flow path, and is configured to select a mode of forming a path connecting the desorption path to all the adsorption towers of the treatment unit and depressurizing all the adsorption towers or a mode of forming a path connecting the desorption path to only one of the adsorption towers and depressurizing only the one adsorption tower.

4. The carbon dioxide removal system according to claim 1, wherein the adsorption towers are filled with an amine-impregnated adsorbent.

5. The carbon dioxide removal system according to claim 4, wherein
the desorption path includes a second recovery path connected to the target space, and
the control device supplies, from the second recovery path to the target space, the treatment target gas recovered by depressurizing the adsorption tower on the upstream side.

6. The carbon dioxide removal system according to claim 1, wherein
the adsorption towers include a heater, and,
when desorption treatment is performed for a substance adsorbed by the adsorption tower, the control device increases a temperature of the target adsorption tower with the heater.

7. A carbon dioxide removal system, comprising:
a treatment target gas acquisition unit that acquires a treatment target gas from a target space;
a flow path that allows the acquired treatment target gas to flow through the flow path;
a first treatment unit that includes two or more adsorption towers connected in series in the flow path along a flow of the treatment target gas;
a second treatment unit that includes two or more adsorption towers connected in series in the flow path along a flow of the treatment target gas, and is disposed in parallel to the first treatment unit; and
a control device that switches between paths of the treatment target gas, wherein
the flow path includes:
a first main path that supplies the treatment target gas to the first treatment unit;
a second main path that is disposed in parallel to the first main path, and supplies the treatment target gas to the second treatment unit;
a first recovery path that discharges, to the target space, the treatment target gas passed through the first main path and the second main path;
a desorption path that is connected to the adsorption towers to be depressurized;
a first branch path that connects a path between the adsorption tower on an upstream side of the first treatment unit and the adsorption tower on a downstream side of the first treatment unit to the first recovery path; and
a switching mechanism that switches a path through which the treatment target gas flows, and
the control device controls the switching mechanism disposed in the flow path, and is configured to switch between a mode of flowing the treatment target gas through all the adsorption towers of the first treatment unit and a mode of flowing the treatment target gas through the first branch path to allow the treatment target gas to flow through the adsorption tower disposed on the upstream side of the first treatment unit and not to allow the treatment target gas to flow through the adsorption tower disposed on the downstream side of the first treatment unit.

8. The carbon dioxide removal system according to claim 7, wherein
the flow path includes a second branch path that connects a path between the adsorption tower disposed on an upstream side of the second treatment unit and the adsorption tower disposed on a downstream side of the second treatment unit to the first recovery path, and
the control device is configured to select a mode of flowing the treatment target gas to all the adsorption towers of the second treatment unit or a mode of flowing the treatment target gas through the second branch path to allow the treatment target gas to flow through the adsorption tower disposed on the upstream side of the second treatment unit and not to allow the treatment target gas to flow through the adsorption tower disposed on the downstream side of the second treatment unit.

9. The carbon dioxide removal system according to claim 7, wherein
the first branch path includes a path connected to the first main path, upstream from the adsorption tower disposed on the upstream side, and
the control device is configured to further select, as a switching target mode, a mode of flowing the treatment target gas through the first branch path to allow the treatment target gas to flow through the adsorption tower disposed on the downstream side of the first treatment unit and not to allow the treatment gas to flow through the adsorption tower disposed on the upstream side.

10. The carbon dioxide removal system according to claim 7, wherein
the desorption path is connected to the upstream side and the downstream side of the adsorption towers, and
the control device is configured to select a mode of forming a path configured to connect the desorption path to only one of the adsorption towers and depressurizing only the one adsorption tower.

11. The carbon dioxide removal system according to claim 7, wherein
the control device simultaneously performs adsorption processing of supplying the treatment target gas to at least one of the adsorption towers of the first treatment unit and the second treatment unit and desorption processing of connecting the adsorption tower to which the treatment target gas is not supplied to the desorption path to desorb an adsorbed substance.

12. The carbon dioxide removal system according to claim 7, wherein the adsorption towers are filled with an amine-impregnated adsorbent.

13. The carbon dioxide removal system according to claim 12, wherein
the desorption path includes a second recovery path connected to the target space, and
the control device supplies, from the second recovery path to the target space, the treatment target gas recovered by depressurizing the adsorption tower on the upstream side.

14. The carbon dioxide removal system according to claim 7, wherein
the adsorption towers include a heater, and,
when desorption treatment is performed for a substance adsorbed by the adsorption tower, the control device increases a temperature of the target adsorption tower with the heater.
